(19) United States
(12) Patent Application Publication
(10) Pub. No.: US 2009/0141008 A1
(43) Pub. Date: Jun. 4, 2009

(54) Electronic Touch Screen Device Providing Signature Capture and Touch Activation

(75) Inventors: Richard Walter Johnson, Raleigh, NC (US); Charles Ray Kirk, Raleigh, NC (US); Susan Ann Luerich, Cary, NC (US)

Correspondence Address: IBM CORPORATION (SS/NC);c/o STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NY (US)

(21) Appl. No.: 11/950,189

(22) Filed: Dec. 4, 2007

(51) Int. Cl. G06F 3/033

(52) U.S. Cl. 345/179

(57) ABSTRACT

A touch screen device comprising a display screen, an electromagnetic digitizer disposed behind the display screen for detecting stylus proximity and stylus coordinates, and an infrared touch device secured in front of the display screen for detecting the coordinates of an infrared opaque object. The touch screen device also includes a controller in electronic communication with the electromagnetic digitizer and the infrared touch device. The controller provides an output signal based upon the infrared opaque object coordinates detected by the infrared touch device during periods of time that the electromagnetic digitizer is not detecting stylus proximity and provides an output signal based upon the stylus coordinates detected by the electromagnetic digitizer during periods of time that the electromagnetic digitizer is detecting stylus proximity. The touch screen device may be used in conjunction with a point-of-sale terminal providing a signal to the display screen and receiving the output signals from the controller.

### BACKGROUND OF THE INVENTION

1. Field of the Invention

The present invention relates to electronic touch screen devices.

2. Description of the Related Art

Electronic input/output devices are necessary for a user to interact with an electronic device, such as a computer. Computers have become prevalent in many business enterprises and are used for a wide variety of applications. The effectiveness of an electronic input/output device is extremely important for leveraging the capabilities of a computer to achieve a given objective. For example, computers are now commonly used as point-of-sale terminals and customers increasingly use an electronic input/output device to make non-cash payment for a sales transaction. Depending upon the mode of payment, a customer may need to select a payment method, scan the magnetic strip on their credit or debit card, enter a personal identification number (PIN), and/or provide a signature. One or more of these steps may be required to authenticate the customer to the retailer or the credit card issuer. Inefficient, counter-intuitive, and unreliable input/output devices used in a retail checkout process are known to cause delays and may result in lost sales or lost customer good will.

Touch screens, including touch pads, allow a customer or other user to provide input to an electronic device by simply touching the screen. Touch screens include displays, such as a liquid crystal display, that provide graphical user interface that can be programmed to intuitively guide the user to touch the screen in a predefined region to select a desired action from among the optional actions that are available. Touch screens are in common use in automated teller machines and kiosks for various purposes. Although touch screens may be made using various technologies, an exemplary touch screen can be made using arrays of infrared transmitters and receivers defining a two-dimensional coordinate system. Touching any position on such a touch screen produces a unique electronic signal that indicates the coordinates of the point that was touched. Unfortunately, infrared touch screens are typically not well adapted for signature capture because of insufficient resolution and scan rate. Alternative touch screen technologies, such as resistive or capacitive touch screens, commonly suffer from rapid deterioration with use, an inability to differentiate between the stylus and the palm of the user's hand resting on the screen, considerable glare in ambient light conditions, and a need for periodic recalibration.

The current best technology for obtaining signature capture is with an electromagnetic digitizer. An electromagnetic digitizer may be implemented on a printed circuit board (PCB) and may be integrated into the back of a liquid crystal display (LCD). A suitable stylus is detected by the electromagnetic digitizer and accurately provides high resolution coordinates. While the stylus may be tethered or untethered, one suitable stylus includes a resonant circuit that obtains energy from a magnetic field generated by the sensor board. The resonant circuit in the stylus then makes use of this energy to return a magnetic signal to the sensor board. The coordinates of the magnetic signal is detected by the sensor board even as the stylus is moved quickly over the LCD or a clear protective layer. Because the digitizer only detects the stylus, the presence of a user's hand on the screen is not detected. Although this is beneficial during signature capture, the electromagnetic digitizer is similarly incapable of detecting touch input from other objects, such as the user's finger, a coin, or a plastic pen cap.

Therefore, there remains a need for an electronic touch screen device that is capable of touch activation using an opaque object as well as high resolution signature capture. It would be desirable if these capabilities did not introduce usability challenges and could be used intuitively.

### SUMMARY OF THE INVENTION

One embodiment of the invention provides an apparatus comprising a display screen, an electromagnetic digitizer disposed behind the display screen for detecting stylus proximity and stylus coordinates, and an infrared touch device secured in front of the display screen for detecting the coordinates of an infrared opaque object. The apparatus also includes a controller in electronic communication with the electromagnetic digitizer and the infrared touch device. The controller provides an output signal based upon the infrared opaque object coordinates detected by the infrared touch device during periods of time that the electromagnetic digitizer is not detecting stylus proximity and provides an output signal based upon the stylus coordinates detected by the electromagnetic digitizer during periods of time that the electromagnetic digitizer is detecting stylus proximity. Stylus proximity may be detected, for example, in response to the electromagnetic digitizer detecting any stylus coordinates. Further embodiments may also include a point-of-sale terminal providing a signal to the display screen and receiving the output signals from the controller.

Another embodiment of the invention provides a method of operating a touch screen device, comprising monitoring proximity of a stylus having a known electromagnetic characteristic relative to the touch screen device using an electromagnetic digitizer disposed beneath the display screen, and switching the output of the touch screen device from the output of an infrared sensor array disposed above the display screen to the output of the electromagnetic digitizer in response to the electromagnetic digitizer detecting the stylus proximity. Output of the infrared sensor array may be used to form the output of the touch screen device during periods of time that the electromagnetic digitizer is not detecting stylus proximity. Conversely, output of the electromagnetic digitizer may be used to form the output of the touch screen device during periods of time that the electromagnetic digitizer is detecting stylus proximity. Preferably, the method may further comprise displaying graphics on the display screen.

In yet another embodiment, the invention provides a computer program product including computer useable instructions embodied on a computer readable medium for operating a touch screen device including an electromagnetic digitizer and an infrared sensor array. The computer program product comprises instructions for monitoring proximity of a stylus having a known electromagnetic characteristic relative to the touch screen device using the electromagnetic digitizer, and instructions for switching the output of the touch screen device from the output of the infrared sensor array disposed above the display screen to the output of the electromagnetic digitizer in response to the electromagnetic digitizer detecting the stylus proximity. The computer program product may further include instructions for carrying out any aspect of the method for operating a touch screen device.

Other embodiments, aspects, and advantages of the invention will be apparent from the following description and the appended claims.

### BRIEF DESCRIPTION OF THE DRAWINGS

FIG. 1 is a perspective view of a point-of-sale terminal in communication with an electronic touch screen device.

FIG. 2 is a perspective view of an electronic touch screen device for touch activation.

FIG. 3 is a perspective view of an electronic touch screen device for signature capture.

FIG. 4 is a cross-sectional diagram of an electronic touch screen device including an electromagnetic digitizer beneath a display screen and an infrared touch device above the display screen.

FIG. 5 is a cross-sectional diagram of the electronic touch screen device of FIG. 4 with a stylus coming into the proximity of the electromagnetic digitizer.

FIG. 6 is a cross-sectional diagram of the electronic touch screen device of FIG. 5 with a stylus and the palm of a hand coming into direct contact with a glass screen over the display screen to provide a signature to the electromagnetic digitizer.

FIG. 7 is a flowchart of a method for operating the electronic touch screen device to obtain coordinates intended for use by the user.

FIG. 8 is a schematic diagram of a computer system that may be configured for use as a point-of-sale terminal.

### DETAILED DESCRIPTION OF PREFERRED EMBODIMENTS

One embodiment of the invention provides an apparatus comprising a display screen, an electromagnetic digitizer disposed behind the display screen for detecting stylus proximity and stylus coordinates, and an infrared touch device secured in front of the display screen for detecting the coordinates of an infrared opaque object. The apparatus also includes a controller in electronic communication with the electromagnetic digitizer and the infrared touch device. The controller provides output based upon the infrared opaque object coordinates detected by the infrared touch device during periods of time that the electromagnetic digitizer is not detecting stylus proximity and provides output based upon the stylus coordinates detected by the electromagnetic digitizer during periods of time that the electromagnetic digitizer is detecting stylus proximity.

The display screen may be any of a variety of available display screens that do not interfere with operation of the electromagnetic digitizer located behind the display screen. For example, the display screen may be a liquid crystal display. Furthermore, it is optional for the electromagnetic digitizer to be integrated with the liquid crystal display.

The electromagnetic digitizer includes an array of sensors that detect when a stylus having a known electromagnetic characteristic comes into proximity of the digitizer. The electromagnetic digitizer is sensitive enough to detect proximity of this stylus as the stylus approaches the display screen, before the stylus is detectable by infrared touch device. A stylus or other object that does not have the known electromagnetic characteristic would generally not be detected by the electromagnetic digitizer, such that the infrared touch device remains operational. In one embodiment, the electromagnetic digitizer operates in at least two modes, including a proximity mode in which the digitizer scans the array of sensors or a subset of the array of sensors at a low scan rate in order to merely detect the proximity of an approaching stylus. The proximity detection may or may not indicate the location where the stylus was detected. However, it is possible for the stylus proximity to be detected in response to the electromagnetic digitizer detecting any stylus coordinates. In either case, subsequent to detecting stylus proximity, the electromagnetic digitizer may increase the scan rate of the array of sensors or a subset of the array of sensor, such as a subset of sensors in a region immediately surrounding the location where the stylus has been detected. The optionally higher scan rate and optionally localized scope of the scan allows the electromagnetic digitizer to provide a higher resolution of the data without generating a needlessly large amount of data.

The stylus itself may include or be connected to an electrical power source or the stylus may be passive. One embodiment of a passive stylus includes a resonant circuit that interacts with an electromagnetic field generated by the electromagnetic digitizer. The operation and design of the stylus and the electromagnetic digitizer are know to those skilled in the art and are beyond the scope of this disclosure.

The infrared touch device may take many forms, but one embodiment of the infrared touch device includes an array of horizontally and transversely arranged infrared light sources and sensors (i.e., arranged along two perpendicular axis within a plane parallel to the display screen) that detect the interruption of a modulated light beam. For example, the infrared touch device may form a frame containing the array of horizontal and transverse infrared light sources and sensors. In one embodiment, the infrared touch device may provide an array of light sources and sensors disposed about a substantially rectangular display screen such that a light source and light senor pair are aligned with each other and enable detection when an object interferes with the light beams therebetween. By detecting interference of the object along first and second axis, such as an X axis and a Y axis of a two dimensional Cartesian coordinate system, the infrared touch device can generate coordinates identifying the position of the object interfering with the light beams.

The controller may be integrated into a common housing with the display screen, electromagnetic digitizer and infrared touch device, or the controller may be within an external system such as a point-of-sale terminal, or some combination thereof. In either case, the controller may be implemented in hardware, firmware, software or some combination. Whatever the form or location of the controller, the controller provides output based upon the infrared opaque object coordinates detected by the infrared touch device during periods of time that the electromagnetic digitizer is not detecting stylus proximity and provides output based upon the stylus coordinates detected by the electromagnetic digitizer during periods of time that the electromagnetic digitizer is detecting stylus proximity. Optionally, the controller may disregard or disable output from the infrared touch device during periods of time that the electromagnetic digitizer is detecting stylus proximity. Similarly, the controller may utilize or enable output from the infrared touch device during periods of time that the electromagnetic digitizer is not detecting stylus proximity. It should be recognized that if the controller is implemented into the touch screen device, then embodiments of the controller output may be provided as an electronic signal sent through a connection cable or a wireless electronic signal transmitted with an antennae. By contrast, if the controller is external to the touch screen device, then the controller function is more likely to be implemented in software code such that an embodiment of the controller output is provide by an application programming interface (API) for used by a point-of-sale application program.

A further embodiment of the invention further includes a point-of-sale terminal providing a signal to the display screen and receiving the output from the controller. In this manner, the point-of-sale terminal causes information to be displayed to the user on the display screen user and prompt the user to interact with the touch screen device in a suitable manner to provide information about the transaction to the point-of-sale terminal. For example, at the appropriate time, the point-of-sale terminal may cause the touch screen device to ask the user to verify the amount of a transaction, to enter a PIN number, or to provide a signature. The display screen may direct the user to provide input in a certain manner and/or provide input in a certain place on the screen. For example, a request for a PIN number may be accompanied by a display representing a standard 0 through 9 keypad and a register window that provides feedback to the user, such as by displaying an asterisk, for each number entered. Similarly, a request for a signature may be accompanied by a display of a rectangular block representing the boundaries within which the signature should be made and provide feedback to the user in the form of displaying a trace of the signature as it is being made.

The touch screen device may include a clear protective layer disposed over the display screen. The clear protective layer may prevent damage to the display screen, but it may also be designed to produce a desirable surface for contact with the stylus. For example, the display screen may be protected by a sheet of etched glass that gives the user a sense of “pen on paper” when the stylus point is moved over the etched glass surface.

Another embodiment of the invention provides a method of operating a touch screen device, comprising monitoring proximity of a stylus having a known electromagnetic characteristic relative to the touch screen device using an electromagnetic digitizer disposed beneath the display screen, and switching the output of the touch screen device from the output of an infrared sensor array disposed above the display screen to the output of the electromagnetic digitizer in response to the electromagnetic digitizer detecting the stylus proximity. Output of the infrared sensor array may be used to form the output of the touch screen device during periods of time that the electromagnetic digitizer is not detecting stylus proximity. Conversely, output of the electromagnetic digitizer may be used to form the output of the touch screen device during periods of time that the electromagnetic digitizer is detecting stylus proximity. Preferably, the method will further comprise displaying graphics on the display screen.

The output of the touch screen device automatically switches between the electromagnetic digitizer and the infrared touch device in order to produce a signal that represent the input intended by the user. If the user does not use the stylus but causes another object to touch the screen, then it is presumed that the user intentionally caused the object to touch the screen and indicates the user's desired input. For example, when a finger touches the surface over a display button, the infrared touch device detects the point of contact, generates the coordinates of the touch, and provides the coordinates to an application program that can matches the coordinates to a function that is associated with the display button. On the other hand, when a stylus approaches the touch screen device, input to the infrared touch device is ignored. Rather, the electromagnetic digitizer detects the coordinates of the stylus and generates output to the application program to take a predetermined action. If the user's hand or some other object makes contact with the touch screen device during the use of the stylus, then that contact is ignored because the stylus input is represents the input intended by the user.

In yet another embodiment, the invention provides a computer program product including computer useable instructions embodied on a computer readable medium for operating a touch screen device including an electromagnetic digitizer and an infrared sensor array. The computer program product comprises instructions for monitoring proximity of a stylus having a known electromagnetic characteristic relative to the touch screen device using the electromagnetic digitizer, and instructions for switching the output of the touch screen device from the output of the infrared sensor array disposed above the display screen to the output of the electromagnetic digitizer in response to the electromagnetic digitizer detecting the stylus proximity. The computer program product may further include instructions for carrying out any aspect of the method for operating a touch screen device.

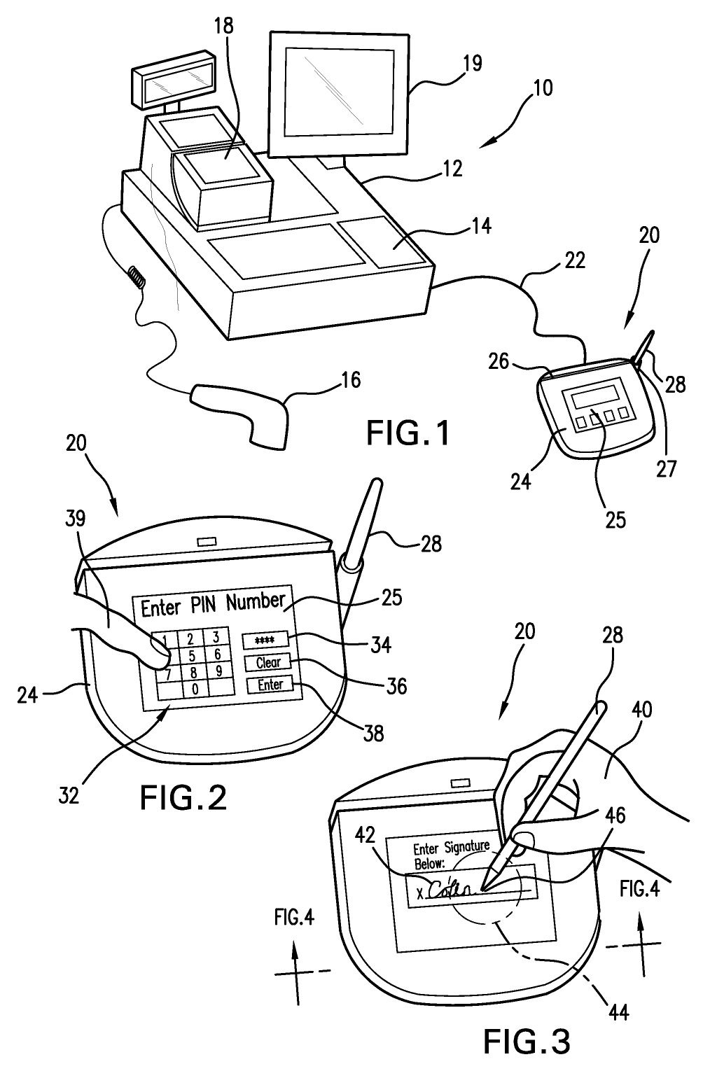

FIG. 1 is a perspective view of an embodiment of a point-of-sale terminal 10 in communication with an embodiment of an electronic touch screen device 20. The point-of-sale terminal 10 includes a processor unit 12, a keyboard 14, a barcode scanner 16, a printer 18 and a display 19. The processor unit 12 is shown in communication with the touch screen device 20 over a communication cable 22. Touch screen device 20 includes a housing 24, display screen 25, credit card reader (magnetic strip reader) 26 and a holder 27 for securing a stylus 28.

FIG. 2 is a perspective view of an embodiment of the electronic touch screen device 20 being used for touch activation. An infrared touch device (not shown) is included in the touch screen device 20 to detect touch by any infrared opaque object, such as a finger, on the surface of the display screen 25. In FIG. 2, the display screen 25 displays a message prompting a user to “Enter PIN Number:” and provides an image of a key pad 32 along with a register window 34, a clear button 36 and an enter button 38. As will be explained later, the infrared touch device is able to detect the position of the touch and provide output indicating the coordinates of the detected position. The finger 39 of a user is contacting the display screen over a portion of the key pad 32 that displays the number four (4). The coordinates of the finger touch are output to a controller that associates the coordinates with the selection of the number four (4) as the desired input. The register window 34 may display a symbol, such as an asterisk (*), for each number entered in this manner so that the user knows that the input was received. Any mistaken entries may be cleared by touching the “Clear” button 36 and a completed PIN Number may be entered by touching the “Enter” button 38.

It should be recognized that touch screen device 20 might be programmed so that this same screen is able to receive input using the stylus 28. The only difference would be that the use of the stylus 28 would negate the use of the infrared touch device in favor of the electromagnetic digitizer. Still, the touch screen device would generate and provide output with coordinates for the stylus that would be associated a displayed button.

FIG. 3 is a perspective view of the electronic touch screen device 20 displaying an image that requests a signature. Here, the stylus 28 is held by a hand 40 and is being used to enter a signature. The infrared touch device is not being used because the stylus is detected by the electromagnetic digitizer. Notably, any contact between the hand 40 and the surface above the display screen 25 is not detected by the electromagnetic digitizer. The display screen 25 is shown displaying a trace 42 of the signature as it is being provided by the user. In a previously mentioned embodiment, the electromagnetic digitizer may increase its scan rate in a region surrounding the present position of the stylus, such as in region 44 surrounding the point of contact 46.

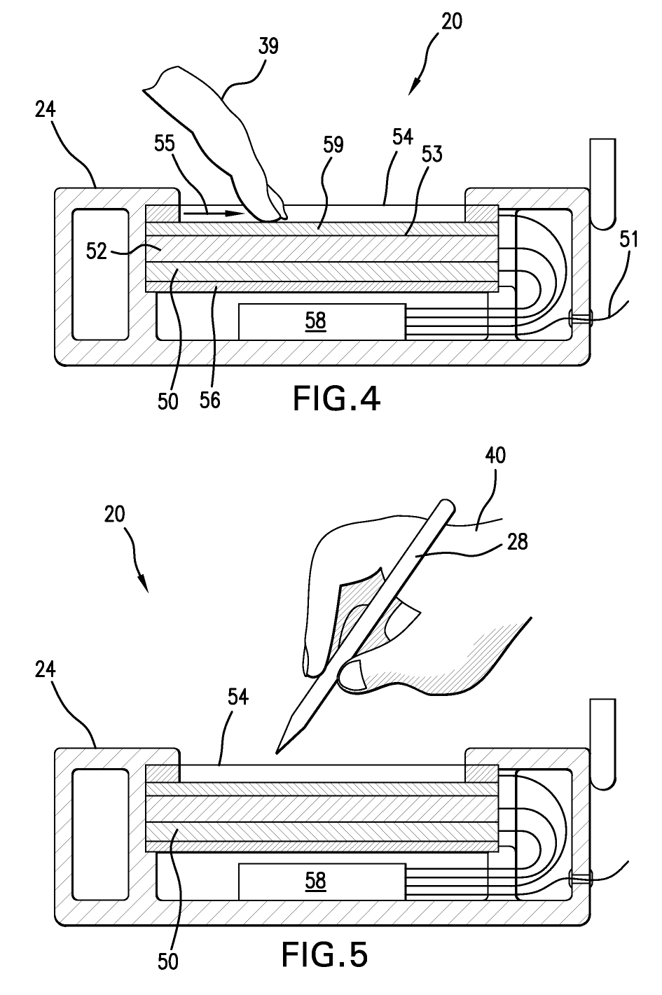

FIG. 4 is a cross-sectional diagram of an embodiment of the electronic touch screen device 20 including an electromagnetic digitizer 50 disposed beneath a liquid crystal display 52 and an infrared touch device 54 above the liquid crystal display 52. A shield 56 is provided below the electromagnetic digitizer 50 in order to prevent an electromagnetic field generated by the controller 58 or other circuitry from interfering with accurate detection of a stylus. In addition, a sheet of etched glass 59 covers the display surface 53 of the liquid crystal display 52. The infrared touch device 54 in this embodiment includes an array of infrared light sources and sensors disposed about the edge of the display surface 53 like a frame. Accordingly, a finger or other object may touch the etched glass 59 above the liquid crystal display 52 and be detected by blocking the path of an infrared beam 55. When the opposing infrared sensor no longer receives the infrared beam 55, it has detected input associated with a position along a single axis of the screen. A similar detection mechanism occurs simultaneously along a perpendicular axis in order for the infrared touch device 54 to provide two dimensional coordinates of the point touched to the controller 58. Output of the device 20 is provided from the controller 58 through an external communication cable 51.

FIG. 5 is a cross-sectional diagram of the electronic touch screen device 20 of FIG. 4 with a stylus 28 coming into the proximity of the electromagnetic digitizer 50. After the stylus 28 is detected by the electromagnetic digitizer 50, perhaps as indicated by the control 58 receiving coordinates from the digitizer 50, the controller 58 switches its attention from the output of the infrared touch device 54 to the output of the electromagnetic digitizer 50. It is within the scope of the invention that the infrared touch device 54 may be turned off or disabled, or the output may be simply ignored or otherwise not treated as the intended input from the user.

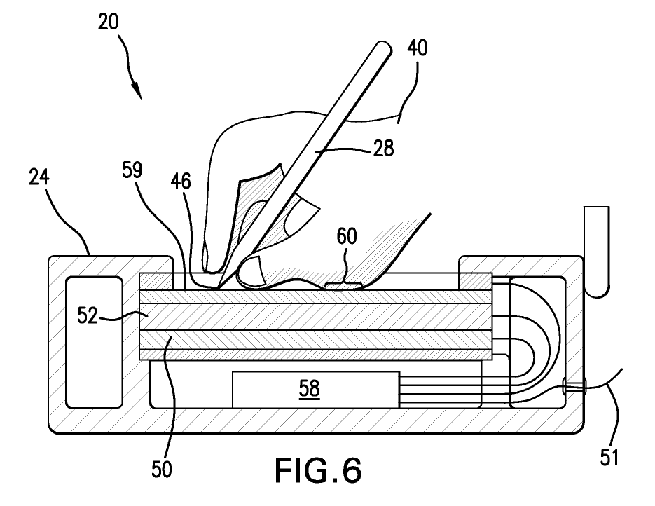

FIG. 6 is a cross-sectional diagram of the electronic touch screen device 20 of FIG. 5 with the stylus 28 and the palm of the hand 40 coming into direct contact with the etched glass 59 over the liquid crystal display 52 to provide a signature to the electromagnetic digitizer 50. In this position, the electromagnetic digitizer 50 is scanning the region about the contact point 46 at a high rate in order to provide a high resolution signature capture. The contact between the hand 40 and the etched glass 59 at region 60 is not detected by the digitizer 50. Accordingly, the output of the controller 58 is a high resolution signature capture obtained from the digitizer 50 and output through the communication cable 51 to a point-of-sale terminal.

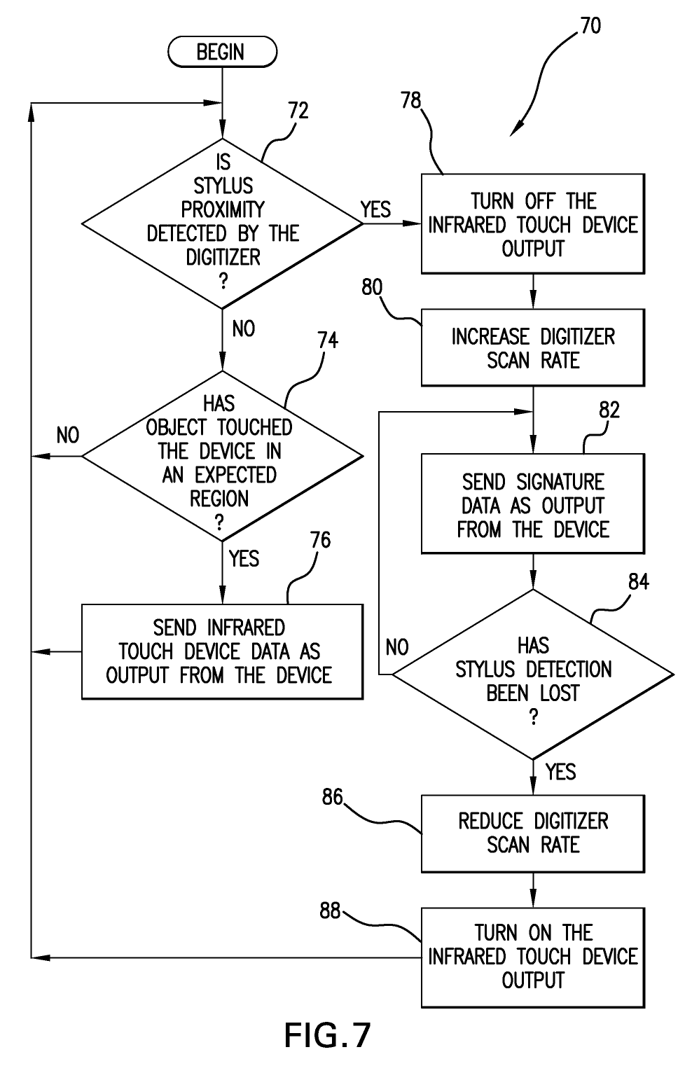

FIG. 7 is a flowchart of one embodiment of a method 70 for operating an electronic touch screen device to obtain coordinates that the user intends as input to the device. The method assumes that the touch screen device includes both an infrared touch device and a digitizer. After the method begins, it is determined whether stylus proximity is detected by the digitizer (step 72). If stylus proximity is not detected, then it is determined whether an object has been detected by the infrared touch device (step 74). If no object has been detected, then the method returns to step 72. In this manner, the method will continue to scan for input into the digitizer or the infrared touch device until input into one of these devices is detected. If an object is detected, as determined in step 74, then the infrared touch device data is output from the touch screen device (step 76).

If stylus proximity is detected in step 72, then the output of the infrared touch device is ignored, disabled or turned off (step 78) and the scan rate of the digitizer is increased (step 80). The digitizer output, such as the data representing a signature capture, is provided as the output from the touch screen device (step 82). The method continues to provide the digitizer output until the digitizer no longer detects the proximity of the stylus (step 84). Accordingly, the scan rate of the digitizer is reduced (step 86) and the digitizer periodically scans for a reintroduction of the stylus at any point over the surface. The infrared touch device is then turned back on, re-enabled, or relied upon again for receiving user input and providing coordinates for the device output (step 88). Variation on the foregoing method may be made with the scope of the invention.

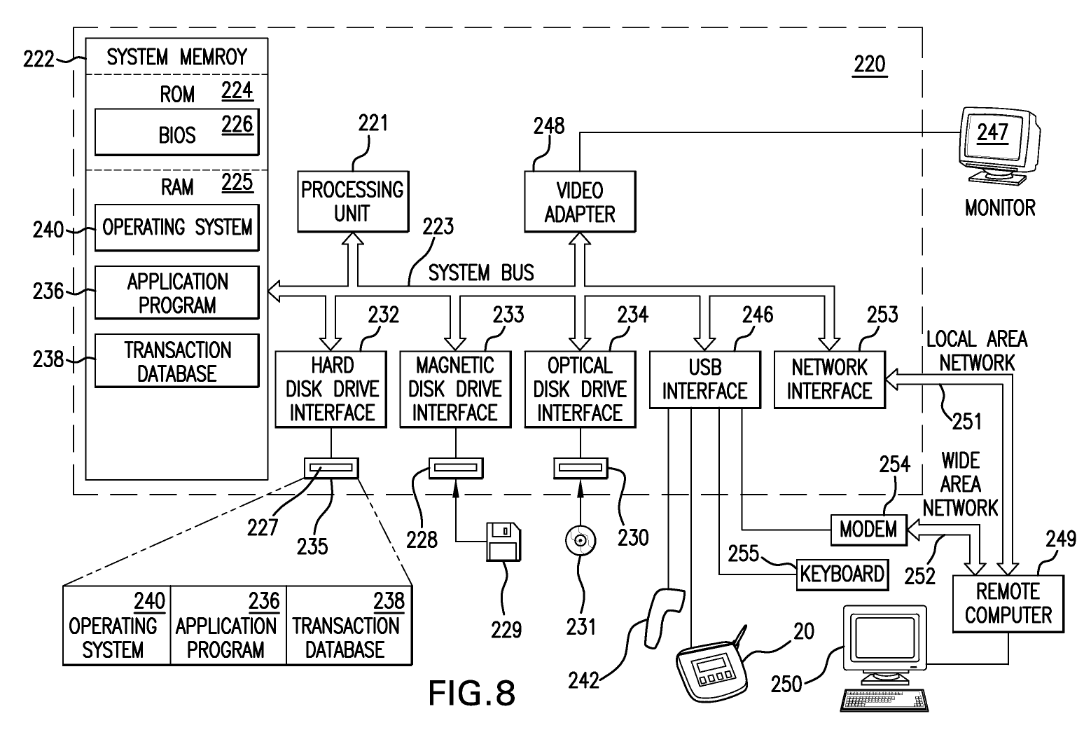

FIG. 8 is a schematic diagram of a computer system 220 that may be configured for use as a point-of-sale terminal. The computer system 220 may be a general-purpose computing device in the form of a conventional computer system 220 or a specialized system. Generally, the computer system 220 includes a processing unit 221, a system memory 222, and a system bus 223 that couples various system devices, including the system memory 222 to processing unit 221. System bus 223 may be any of several types of bus structures including a memory bus or memory controller, a peripheral bus, and a local bus using any of a variety of bus architectures. The system memory includes a read only memory (ROM) 224 and random access memory (RAM) 225. A basic input/output system (BIOS) 226 is stored in ROM 224, containing the basic routines that help to transfer information between elements within computer system 220, such as during start-up.

The computer system 220 further includes a hard disk drive 235 for reading from and writing to a hard disk 227, a magnetic disk drive 228 for reading from or writing to a removable magnetic disk 229, and an optical disk drive 230 for reading from or writing to a removable optical disk 231 such as a CD-R, CD-RW, DV-R, or DV-RW. Hard disk drive 235, magnetic disk drive 228, and optical disk drive 230 are connected to system bus 223 by a hard disk drive interface 232, a magnetic disk drive interface 233, and an optical disk drive interface 234, respectively. Although the exemplary environment described herein employs hard disk 227, removable magnetic disk 229, and removable optical disk 231, it should be appreciated by those skilled in the art that other types of computer readable media which can store data that is accessible by a computer, such as magnetic cassettes, flash memory cards, digital video disks, Bernoulli cartridges, RAMs, ROMs, USB Drives, and the like, may also be used in the exemplary operating environment. The drives and their associated computer readable media provide nonvolatile storage of computer-executable instructions, data structures, program modules, and other data for computer system 220. For example, the operating system 240 and application programs 236 may be stored in the RAM 225 and/or hard disk 227 of the computer system 220.

A user may enter commands and information into computer system 220 through input devices, such as a keyboard 255, a barcode scanner 242, and the touch screen device 20. Other input devices (not shown) may include a microphone, joystick, game pad, touch pad, satellite dish, scanner, or the like. These and other input devices are often connected to processing unit 222 through a USB (universal serial bus) 246 that is coupled to the system bus 223, but may be connected by other interfaces, such as a serial port interface, a parallel port, game port, or the like. A display device 247 (such as display 19 in FIG. 1) may also be connected to system bus 223 via an interface, such as a video adapter 248. In addition to the monitor, personal computers typically include other peripheral output devices (not shown), such as speakers and printers, including printer 18 shown in FIG. 1.

The computer system 220 may operate in a networked environment using logical connections to one or more remote computers 249. each of the one or more remote computers 249 may be another personal computer, a server, a client, a router, a network PC, a peer device, a mainframe, a personal digital assistant, an internet-connected mobile telephone or other common network node. While a remote computer 249 typically includes many or all of the elements described above relative to the computer system 220, only a memory storage device 250 has been illustrated in FIG. 6. The logical connections depicted in the figure include a local area network (LAN) 251 and a wide area network (WAN) 252. Such networking environments are commonplace in offices, enterprise-wide computer networks, intranets, and the internet.

When used in a LAN networking environment, the computer system 220 is often connected to the local area network 251 through a network interface or adapter 253. When used in a WAN networking environment, the computer system 220 typically includes a modem 254 or other means for establishing high-speed communications over WAN 252, such as the internet. Modem 254, which may be internal or external, is connected to system bus 223 via USB interface 246. In a networked environment, program modules depicted relative to computer system 220, or portions thereof, may be stored in the remote memory storage device 250. It will be appreciated that the network connections shown are exemplary and other means of establishing a communications link between the computers may be used.

Program modules may be stored on hard disk 227, optical disk 231, ROM 224, RAM 225, or even magnetic disk 229. The program modules may include portions of an operating system 240, application programs 236, or the like. A transaction database 238 may be included, which may store transaction amounts, transaction authorization codes, and captured digital signatures.

Aspects of the present invention may be implemented in the form of an application program 236. Application program 236 may be informed by or otherwise associated with the transaction database 238. The application program 236 generally comprises computer-executable instructions for carrying out a point-of-sale transaction, and may optionally perform the functions of the controller.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus, comprising:
a display screen;
an electromagnetic digitizer disposed behind the display screen for detecting stylus proximity and stylus coordinates;
an infrared touch device secured in front of the display screen for detecting the coordinates of an infrared opaque object; and
a controller in electronic communication with the electromagnetic digitizer and the infrared touch device, wherein the controller provides output based upon the infrared opaque object coordinates detected by the infrared touch device during periods of time that the electromagnetic digitizer is not detecting stylus proximity and provides output based upon the stylus coordinates detected by the electromagnetic digitizer during periods of time that the electromagnetic digitizer is detecting stylus proximity.

2. The apparatus of claim 1, wherein the stylus proximity is detected in response to the electromagnetic digitizer detecting any stylus coordinates.

3. The apparatus of claim 1, wherein the controller disables output from the infrared touch device during periods of time that the electromagnetic digitizer is detecting stylus proximity and enables output from the infrared touch device during periods of time that the electromagnetic digitizer is not detecting stylus proximity.

4. The apparatus of claim 1, wherein the controller disregards input from the infrared touch device during periods of time that the electromagnetic digitizer is detecting stylus proximity.

5. The apparatus of claim 1, further comprising:
a clear protective layer disposed over the display screen.

6. The apparatus of claim 1, wherein the clear protective later is etched glass.

7. The apparatus of claim 1, wherein the infrared touch device comprises an array of vertical and horizontal infrared light sensors that detect the interruption of a modulated light beam.

8. The apparatus of claim 7, wherein the infrared touch device forms a frame containing the array of vertical and horizontal infrared light sensors.

9. The apparatus of claim 1, wherein the stylus does not have an electrical power source.

10. The apparatus of claim 9, wherein the stylus has a resonant circuit.

11. The apparatus of claim 1, further comprising:
a point-of-sale terminal providing a signal to the display screen and receiving the output signals from the controller.

12. A method of operating a touch screen device, comprising:
monitoring proximity of a stylus having a known electromagnetic characteristic relative to the touch screen device using an electromagnetic digitizer disposed beneath a display screen; and
switching the output of the touch screen device from the output of an infrared sensor array disposed above the display screen to the output of the electromagnetic digitizer in response to the electromagnetic digitizer detecting the stylus proximity.

13. The method of claim 12, further comprising:
using the output of the infrared sensor array to form the output of the touch screen device during periods of time that the electromagnetic digitizer is not detecting stylus proximity.

14. The method of claim 13, further comprising:
using the output of the electromagnetic digitizer to form the output of the touch screen device during periods of time that the electromagnetic digitizer is detecting stylus proximity.

15. The method of claim 12, further comprising:
displaying graphics on the display screen.

16. A computer program product including computer useable instructions embodied on a computer readable medium for operating a touch screen device including an electromagnetic digitizer and an infrared sensor array, comprising:
instructions for monitoring proximity of a stylus having a known electromagnetic characteristic relative to the touch screen device using the electromagnetic digitizer disposed below a display screen; and
instructions for switching the output of the touch screen device from the output of the infrared sensor array disposed above the display screen to the output of the electromagnetic digitizer in response to the electromagnetic digitizer detecting the stylus proximity.

17. The computer program product of claim 16, wherein the infrared sensor array is disposed above a display screen and the electromagnetic digitizer is disposed below the display screen.

18. The computer program product of claim 16, further comprising:
instructions for using the output of the infrared sensor array to form the output of the touch screen device during periods of time that the electromagnetic digitizer is not detecting stylus proximity.

19. The computer program product of claim 18, further comprising:
instructions for using the output of the electromagnetic digitizer to form the output of the touch screen device during periods of time that the electromagnetic digitizer is detecting stylus proximity.

20. The computer program product of claim 16, further comprising:
instructions for displaying graphics on the display screen.
